(19) United States
(12) Patent Application Publication
(10) Pub. No.: US 2022/0369678 A1
(43) Pub. Date: Nov. 24, 2022

(54) A PROCESS FOR PREPARING CHICKPEA FLOUR

(71) Applicant: SUPPLANT FOODS LLP, PUNE (IN)

(72) Inventors: Paresh SHAH, PUNE (IN); Chirag SABUNANI, PUNE (IN)

(21) Appl. No.: 17/771,496

(22) PCT Filed: Oct. 16, 2020
(86) PCT No.: PCT/IN2020/050885

§ 371 Date: Apr. 25, 2022

(30) Foreign Application Priority Data
Oct. 25, 2019 (IN) 201921043550

(51) Int. Cl. A23L 11/30; A23L 11/00

(52) U.S. Cl. CPC A23L 11/31; A23L 11/05

(57) ABSTRACT

The present invention relates to a process for preparing chickpea flour having an increased function of the chickpea protein wherein the process efficiently removes the compounds responsible for the off flavor or nutty flavor of the chickpea flour without deteriorating its functionality. The process for preparation of the chickpea flour includes steps such as: preparing the chickpeas to obtain broken chickpeas; treating the broken chickpeas to obtain chickpea flakes; deoiling the chickpea flakes using a predefined solvent to extract compounds responsible for off-flavor; generating chickpea flour from the deoiled chickpea flakes; and recycling the solvent used for deoiling. The process imparts different functional properties to the chickpea flour that are desired in baking applications and to use it as vegan food ingredient in vegan egg replacer and vegan dairy replacement.

### FIELD OF THE INVENTION

The present invention relates to a process for preparing chickpea flour and more particularly, to an improved process for preparing chickpea flour.

### BACKGROUND OF THE INVENTION

The chickpea (Cicer arietinum) is a legume of the family Fabaceae. Chickpeas are one of the legumes whose usage dates back to prehistoric times. Remains of chickpea, as old as 7,500 years, have been found in the Middle East. Chickpea is a leguminous crop widely grown in many subtropical and warm-temperate regions of the world and originated from the Mediterranean region. Chickpea is also known as garbanzo beans. Chickpea has a high nutritive value and is a rich source of carbohydrates, vitamins, proteins, minerals and fiber. Chickpeas contain various nutrients such as folate, copper, zinc and iron. They are also very high in dietary fiber and hence a good source of carbohydrates for persons with insulin sensitivity or diabetes. Chickpeas are a major source of proteins. Chickpeas are low in fat and most of this is polyunsaturated. Chickpeas have a variety of health benefits ranging from improving digestion, aiding weight management and reducing the risk of several diseases.

Conventionally, chickpeas are consumed as a whole in cooked form. Chickpeas are widely used in the cuisines of the Mediterranean, India, the Middle East, and in various Mexican dishes. Chickpeas can be cooked and eaten as salads or used in stews and soups. They also can be ground into a flour called gram flour, ground and shaped in balls and fried as falafel, stirred into a batter and baked to make farinata, cooked and ground into a paste called hummus, or roasted, spiced, and eaten as a snack. Chick peas and bengal grams are also used to make curries. Chickpeas are also consumed in the form of flour. It is prepared by grinding whole dried chickpeas. The flour is used as a part of various delicacies. It is used in a wide range of applications, including bakery and confectionary, beverages, animal feed and dairy products.

Chickpea flour has a growing demand in baking applications as a gluten free and as a vegan ingredient in plant-based foods. The nutty flavor of the flour limits its use for such applications. This nutty or off flavor property is attributed to the presence of various volatile and non-volatile compounds naturally occurring in the chickpea. Volatile off-flavour compounds belong to the categories of aldehydes, alcohols, ketones, acids and pyrazines. Non-volatile compounds belong to the categories of phenolic compounds, saponins and sometimes alkaloids. The off-flavour of the chickpea can also be attributed to process conditions such as oxidation of unsaturated fatty acids (e.g., linoleic and linolenic acids). This oxidation is due to exposure to oxygen and activation of lipoxygenase enzyme leading to development of off-flavour compounds. Furthermore, off-flavors can be formed by the effect of heat on sugars and amino acids, such as Maillard reactions, by thermal degradation of phenolic acids, by oxidative and thermal degradation of carotenoids and by thermal degradation of thiamine. Hence, to be used for baking applications and as a vegan ingredient in plant-based foods, the flour needs to be processed to render it tasteless and flavorless without deteriorating its functionality.

Various attempts have been made in the prior art to process chickpea flour. The PCT Application WO2019057680 discloses a method for producing pregelatinized chickpea flour. The aim of the cited process is to produce chickpea flour that is further suitable for specific products such as hummus. The cited process suggests the removal of a few volatile compounds using acidification. The flour produced by the said process is useful for specific applications only. The U.S. Patent Application 2016/0309743 discloses a system and method for generating a protein concentrate from chickpeas. The cited method involves generating alkalized slurry by combining flour, water and a base and generating a solubilized rich protein stream therefrom. The cited method discloses use of vacuum evaporators at high temperatures for removing aromatics but does not disclose the details of the aromatics removed. Moreover use of high temperature leads to denaturation of proteins. These prior art processes are either expensive, have reduced volume functionality or have high carbon footprint and have limited applications.

There is a need for a process for the preparation of chickpea flour having an increased function of the chickpea protein. Also, there is a need of a process for preparation of chickpea flour that removes compounds responsible for the off flavor or nutty flavor of the chickpea flour without deteriorating its functionality.

### SUMMARY OF THE INVENTION

The present invention relates to an improved process for preparing chickpea flour.

In one aspect, the present invention relates to an improved process for preparing chickpea flour having an increased function of the chickpea protein.

In another aspect, the present invention relates to an improved process for preparing chickpea flour that efficiently removes the compounds responsible for the off flavor or nutty flavor of the chickpea flour without deteriorating its functionality.

In a preferred embodiment, a process for preparation of chickpea flour is disclosed.

The process includes the step of preparing the chickpeas to obtain broken chickpeas followed by treating the broken chickpeas to obtain chickpea flakes. In the next step, deoiling of the chickpea flakes is done using a predefined solvent to extract compounds responsible for off-flavor. In the further step, chickpea flour is generated from the deoiled chickpea flakes followed by recycling of the solvent used for deoiling.

The detailed process for preparation of chickpea flour is described in detail hereinafter. In the first step of preparing chickpeas, the chickpeas are cleaned in a classifier separator to remove all the foreign and unwanted matter followed by splitting the chickpeas in a splitter machine. The split chickpeas are cracked into broken chickpeas by the cracker mill to obtain cracks of splits followed by removal of residual powder generated in the previous step using an aspirator.

In the next step of treating the broken chickpeas, the broken chickpeas are fed into a vessel with stirrer via a screw conveyor with addition of water to achieve a predefined moisture level followed by conditioning of the broken chickpeas by resting it for a predefined period of time with intermittent stirring or continuous slow stirring to attain moisture equilibrium. These conditioned broken chickpeas are then cooked for a predefined period of time with intermittent stirring or continuous slow stirring in a vessel jacketed with water of a predefined temperature. These cooked broken chickpeas are fed into a flaker machine to obtain chickpea flakes of predefined thickness.

In the further step of deoiling the chickpea flakes, the chickpea flakes are deoiled in an extractor vessel using a predefined solvent, wherein the extractor is heated at a predefined temperature using hot water followed by draining the remaining solvent with miscella of the previous step. The deoiled chickpea flakes are then fed into a vacuum evaporator via a conveyor from extractor to evaporator and keeping the chickpea flakes in intermittent or continuous slow stirring in the extractor.

In the next step of generating chickpea flour, the chickpea flakes are desolventised by stirring continuously in the vacuum evaporator, wherein the vacuum is maintained at a predefined pressure and the water jacket is maintained at a predefined temperature, to a point where the solvent content is reduced. These deoiled, desolventized chickpea flakes are then transferred into a vessel to allow cooling of the chickpea flakes to an ambient temperature followed by feeding the chickpea flakes to an air classifying mill (ACM) where the chickpea flakes are ground to give chickpea flour of desired particle size.

In the last step of recycling the solvent, the miscella (oil with solvent) generated in the deoiling step of the process is fed into an evaporator wherein the oil is separated from the miscella by evaporating the solvent followed by feeding the diluted solvent to a rectification column to rectify it to a concentration range of 95% to 96% and then recycling back the solvent to the process again.

In accordance with this embodiment, the cracker mill is used to obtain broken chickpeas of size less than 4.5 mm and more than 2 mm. The predefined moisture level of the broken chickpeas for cooking ranges from 12-15%. The predefined period of time used for conditioning ranges from 30-150 minutes. The predefined period of time used for cooking ranges from 100-120 minutes. The predefined temperature of the water jacket used for cooking ranges from 60° C.-70° C. The predefined thickness of the chickpea flakes is in the range of 0.3 mm to 0.8 mm.

The predefined solvent used for deoiling the chickpea flakes is selected from various polar and/or nonpolar solvents. Exemplary polar solvents include one or more of methanol, ethanol and acetic acid. Exemplary non-polar solvents include one or more of carbon tetrachloride, benzene, diethyl ether, hexane and methylene chloride. The concentration of the solvent used is 95% to 96%. The predefined temperature used to heat the extractor vessel is 45° C. to 50° C. with the help of hot water present in the jacket of extractor.

In the desolventisation step, the predefined pressure in the vacuum evaporator is maintained at 60 to 300 Torr (mmHG) and predefined temperature of the water jacket is maintained at 50° C. to 55° C. Addition of water for conditioning the chickpeas ensures that the final product has the desired color, emulsifying properties, foaming properties and gelling properties. Adding moisture is the key to not only achieve the partial pregelling but also to maintain the moisture level of the chickpeas. When the solvents are used for deoiling the chickpeas they reduce moisture content of the chickpeas. Since water is added during conditioning, overall moisture loss does not happen. Thus, the moisture levels are maintained at optimum and the roasting of flour that leads to protein denaturation is prevented.

A slow cooking method or controlled cooking method is used for cooking the chickpeas that helps to achieve different degrees of pregelling starch in it. The use of water jacket for cooking at the specified temperature allows the properties of the chickpea to be preserved. Moreover, the protein present in the chickpeas is preserved from any damages that may occur due to use of high temperatures. It is noted however that the combination of the steps of cracking and cooking before flaking leads to the transformation of properties of the chickpea. The process of the present invention is also suitable for manufacturing of flours from various legumes such as pulses and beans. The process imparts different functional properties to the chickpea flour that are desired in baking applications and to use it as vegan food ingredient in vegan egg replacer and vegan dairy replacement.

### DETAILED DESCRIPTION OF THE INVENTION

The invention described herein is explained using specific exemplary details for better understanding. However, the invention disclosed can be worked on by a person skilled in the art without the use of these specific details.

References in the specification to “one embodiment” or “an embodiment” means that particular feature, structure, characteristic, or function described in connection with the embodiment is included in at least one embodiment of the invention. The appearances of the phrase “in one embodiment” in various places in the specification are not necessarily all referring to the same embodiment.

References in the specification to “preferred embodiment” means that a particular feature, structure, characteristic, or function described in detail thereby omitting known constructions and functions for clear description of the present invention.

The foregoing description of specific embodiments of the present invention has been presented for purposes of illustration and description. They are not intended to be exhaustive or to limit the present invention to the precise forms disclosed, and obviously many modifications and variations are possible in light of the above teaching.

The present invention relates to a process for the preparation of chickpea flour. The process for the preparation of chickpea flour in accordance with the present invention includes steps of preparation, treatment, deoiling broken chickpeas, generating chickpea flour, and recycling. In accordance with the present invention a preferred process for preparation of the chickpea flour includes steps such as:
i. preparing the chickpeas to obtain broken chickpeas;
ii. treating the broken chickpeas to obtain chickpea flakes;
iii. deoiling the chickpea flakes using a predefined solvent to extract compounds responsible for off-flavor;
iv. generating chickpea flour from the deoiled chickpea flakes; and
v. recycling the solvent used for deoiling.
   It is to be noted however that each of the steps further includes sub-steps. Accordingly, a detailed process for preparation of chickpea flour of the present invention is described in detail hereinafter.
      The first step of preparing chickpeas further includes:
a. cleaning the raw chickpeas in a classifier separator to remove all the foreign and unwanted matter from the raw material;
b. feeding the aforesaid chickpeas into a splitter machine to obtain the chickpea splits;
c. feeding the splits into a cracker machine to crack them into broken chickpeas; and
d. removing the residual powder generated in the previous step using an aspirator.
   The second step of treating the broken chickpeas further includes:
a. feeding the broken chickpeas into a vessel with stirrer, via a screw conveyor with addition of water to achieve a predefined moisture level;
b. conditioning of the broken chickpeas by resting the chickpeas for a predefined period of time with intermittent stirring or continuous slow stirring to attain moisture equilibrium;
c. cooking the conditioned broken chickpeas for a predefined period of time with intermittent stirring or continuous slow stirring in a vessel jacketed with water of a predefined temperature; and
d. feeding the cooked broken chickpeas of the previous step into a flaker machine to obtain chickpea flakes of predefined thickness.
   The third step of deoiling the chickpea flakes further includes:
a. deoiling of the chickpea flakes in an extractor vessel using a predefined solvent, wherein the extractor is heated at a predefined temperature using hot water; and
b. draining the remaining solvent with miscella of the previous step and feeding the deoiled chickpea flakes of the previous step into a vacuum evaporator, via a conveyor from extractor to evaporator and keeping the chickpea flakes in intermittent or continuous slow stirring in the extractor.
   The fourth step of generating chickpea flour from the deoiled chickpea flakes further includes:
a. desolventizing the chickpea flakes by stirring continuously in the vacuum evaporator, where the vacuum is maintained at a predefined pressure and the water jacket is maintained at a predefined temperature, to a point where the solvent content is reduced;
b. transferring the deoiled, desolventized chickpea flakes into a vessel to allow cooling of the chickpea flakes to an ambient temperature; and
c. feeding the chickpea flakes of the previous step to an air classifying mill (ACM) where the chickpea flakes are ground to give chickpea flour of desired particle size.
   The last step of recycling the solvent further includes:
a. feeding the miscella (oil with solvent) generated in the deoiling step of the process into an evaporator wherein the oil is separated from the miscella by evaporating the solvent; and
b. feeding the diluted solvent to a rectification column to rectify it to a concentration range of 95% to 96% and then recycling back the solvent to the process again.

In accordance with this embodiment, the first step of preparing chickpeas further includes cleaning of raw chickpeas, obtaining chickpea splits and cracking split chickpeas into broken chickpeas; wherein various equipment are used for each of the sub-step.

In this embodiment of the present invention, raw desi chickpeas or kabuli chickpeas or split chickpeas are used as raw material. A classifier separator is used to remove all the foreign and unwanted matter from the raw material. The unwanted husk, germs and powder generated during the cleaning of chickpeas is discarded. Various methods known in the prior art used to split the chickpeas. Preferably a splitter machine known in the prior art is used to split the chickpeas. Various methods known in the prior art are used to obtain broken chickpeas. Preferably a cracker machine known in the prior art is used to make broken chickpeas. The cracker mill is advantageously used to obtain broken chickpeas of size preferably less than 4.5 mm and more than 2 mm.

In accordance with this embodiment, the second step of treating the broken chickpeas further includes conditioning and cooking of broken chickpeas and obtaining chickpea flakes; wherein water is added to achieve a predefined level and the sub-steps of conditioning and cooking are done for a predefined period of time and predefined period of temperature to obtain chickpea flakes of predefined thickness.

In this embodiment of the present invention, the broken chickpeas are fed to a vessel with stirrer, via a screw conveyor wherein water is added to achieve a predefined moisture level ranging from 12-15%. The said moisture level ensures good cooking for partial pregelling of starch present in the chickpeas. The chickpeas are conditioned by resting them for a predefined period of time ranging from 30-150 minutes in accordance with the present invention. During the conditioning of broken chickpeas, increase or decrease of water addition changes the degree of pregelling. In accordance with the present invention, the conditioned broken chickpeas are cooked in a vessel with intermittent stirring or continuous slow stirring for a predefined time period ranging from around 100-120 minutes. Increase or decrease in the cooking time affects the pregelling of starch. In accordance with the present invention, the said vessel used for cooking is jacketed with water having a predefined temperature ranging from 60° C.-70° C. In accordance with the present invention, the cooked broken chickpeas are fed to a flaker machine, wherein the flaker machine includes two rolls revolving in opposite direction. The thickness of chickpea flakes is adjusted by adjusting the gap between the two rolls. The predefined thickness of the obtained chickpea flakes is in the range of 0.3 mm to 0.8 mm. Any powder or flour generated during flaking, is removed by vibratory sifters, and discarded.

In accordance with this embodiment, the third step of deoiling the chickpea flakes further includes deoiling of the chickpea flakes and transferring the deoiled chickpea flakes to a vacuum evaporator, wherein a predefined solvent is used for deoiling of the chickpea flakes in an extractor at a predefined temperature using hot water.

In this embodiment, the predefined solvent used for deoiling the chickpea flakes is selected from various polar and/or nonpolar solvents. Exemplary polar solvents include one or more of methanol, ethanol and acetic acid. Exemplary non-polar solvents include one or more of carbon tetrachloride, benzene, diethyl ether, hexane and methylene chloride. The concentration of the solvent used is 95% to 96%. Solvent is taken out constantly with constantly pouring fresh or azeotrope form or distilled solvent from the process itself. In accordance with the invention, the predefined temperature used to heat the extractor vessel is 45° C. to 50° C. with the help of hot water present in the jacket of extractor. Temperature is maintained during the process.

In accordance with this embodiment, the fourth step of generating chickpea flour from the deoiled chickpea flakes further includes desolventizing the chickpea flakes, cooling the chickpea flakes and feeding the chickpea flakes in an air classifying mill (ACM) where the chickpea flakes are ground to give chickpea flour, wherein in the vacuum is maintained at a predefined pressure and the water jacket is maintained at a predefined temperature for desolventization. The sub-step of desolventization takes place in a vacuum evaporator wherein the predefined pressure is maintained at 60 to 300 Torr (mmHG) and predefined temperature of the water jacket is maintained at 50° C. to 55° C. Advantageously, the use of specified pressure and temperature for desolventizing the chickpea flakes keeps the properties of the chickpea intact. The stirring and the vacuum facilitates the desolventization process leading to removal of solvent without using high temperatures. The desolventized chickpea flakes are milled in a specialized air classification system, to obtain chickpea flour.

It is noted, that the addition of water for conditioning the chickpeas ensures that the final product has the desired color, emulsifying properties, foaming properties and gelling properties. Adding moisture is the key to not only achieve the partial pregelling but also to maintain the moisture level of the chickpeas. When the solvents are used for deoiling the chickpeas they reduce moisture content of the chickpeas. Since water is added during conditioning, overall moisture loss does not happen. Thus, the moisture levels are maintained at optimum and the roasting of flour that leads to protein denaturation is prevented. A slow cooking method or controlled cooking method is used for cooking the chickpeas that helps to achieve different degrees of pregelling starch in it. The use of water jacket for cooking at the specified temperature allows the properties of the chickpea to be preserved. Moreover, the protein present in the chickpeas is preserved from any damages that may occur due to use of high temperatures. It is noted however that the combination of the steps of cracking and cooking before flaking leads to the transformation of properties of the chickpea.

The solvent leads to removal of the compounds responsible for the off flavor and off taste of the chickpea. The solvent also removes lipids such as phosphatidylcholine, a compound responsible for bitterness. Using 95% ethanol leads to partial inactivation of trypsin inhibitor and partial activation of enzymes that are responsible for limited protease activities in chickpeas resulting in partial hydrolysis of proteins. The partial hydrolysis of proteins leads to improved functionality of the flour produced by the process of the invention. The partial hydrolysis of proteins leads to improved emulsification and gelling properties of the flour.

The cracking of the chickpeas in the process leads to oxidation of lipids in presence of the enzyme lipoxygenase (LOX). The compounds formed due to oxidation are responsible for off flavor. Moreover, these compounds attach to the protein. To overcome this problem, it is necessary to inactivate the enzyme lipoxygenase. This is achieved by ensuring minimum time between making the chickpea flakes and extraction to avoid the off flavor formations and their attachment to proteins. The LOX activity is also reduced by the use of ethanol as solvent. The off flavors that develop due to thermal degradation of phenolic acids present in the chickpea are avoided by using temperatures lower than 70° C. The use of low temperature prevents thermal degradation of proteins present in the chickpea. The foaming activity of the flour prepared by the process of the invention is increased due to removal of foaming inhibitors present in the chickpeas.

The flour manufactured from the process is flavorless, tasteless, and has pregelled starch and less than 1% oil in it, that gives different functional properties desired in baking applications and to use it as vegan food ingredient in vegan egg replacer and vegan dairy replacement. In context of the present invention, the process of the present invention advantageously uses temperatures up to 70° C. thus preventing protein denaturation and keeps the functionality of the flour intact. The process is not a wet process hence lowers the carbon footprint. The process does not use open steam in any of the steps thus maintains the protein behavior. The process of the invention allows increased foaming, emulsifying, gelling, networking, rising ability of the flour that is not present in the regular chickpea flour or steamed chickpea flour. The de-oiling of chickpea flakes under the specific conditions of pressure and temperature ensures that the final product has the desired color, emulsifying properties, foaming properties and gelling properties.

The process of the present invention is also suitable for manufacturing of flours from various legumes such as pulses and beans.

The present invention is further illustrated by following exemplary embodiments, which should not be construed as limiting the scope of the invention.

### EXAMPLES

### Example 1

### Process for the Preparation of Chickpea Flour

Preparation of chickpeas to obtain broken chickpeas: Chickpeas are cleaned in a classifier separator to remove all the foreign and unwanted matter followed by splitting the chickpeas in a splitter machine. The split chickpeas are cracked into broken chickpeas by the cracker mill to obtain cracks of splits to a level of less than 4.5 mm and more than 2 mm.

Treatment of the broken chickpeas to obtain chickpea flakes: In a vessel with stirrer, water is added to the broken chickpeas to achieve a moisture level of 13-14% followed by conditioning of the broken chickpeas by resting the broken chickpeas for 60-80 min with intermittent stirring. After resting, the broken chickpeas are cooked in a closed vessel (without open steam) having a water jacket at 63° C.-68° C., with intermittent stirring for 100-120 minutes. In the next step, chickpea flakes of 0.4 mm-0.7 mm thickness are made from the cooked broken chickpeas.

Deoiling of the chickpea flakes: Deoiling of the chickpea flakes is done in an extractor using ethanol as the solvent at a temperature of 45° C.-50° C. with continuous pouring of fresh/distilled ethanol on the chickpea flakes and taking out the miscella (oil and solvent mixture). Next, the miscella is drained out from the extractor after deoiling of chickpea flakes is done

Generation the chickpea flour: The deoiled chickpea flakes are transferred to a vacuum evaporator. The chickpea flakes are then desolventized at a temperature of 50° C.-55° C. and vacuum of 60-70 mm Hg(torr). The chickpea flakes are deoiled and white. Now the white deoiled chickpea flakes are ground in ACM to a desired particle size to get functional, flavorless and tasteless chickpea flour.

Recycling of solvent: The miscella (oil with ethanol) generated in the deoiling step is fed to an evaporator, wherein the oil is separated from the miscella by evaporating ethanol. The diluted ethanol is fed to rectification column to rectify it to level of 95-96% concentration and then used in the process again.

The embodiments were chosen and described in order to best explain the principles of the present invention and its practical application, to thereby enable others, skilled in the art to best utilize the present invention and various embodiments with various modifications as are suited to the particular use contemplated.

It is understood that various omission and substitutions of equivalents are contemplated as circumstance may suggest or render expedient, but such are intended to cover the application or implementation without departing from the scope of the present invention.

1. A process for preparing chickpea flour comprising the steps of:
i. preparing the chickpeas to obtain broken chickpeas;
ii. treating the broken chickpeas to obtain chickpea flakes;
iii. deoiling the chickpea flakes using a predefined solvent to extract compounds responsible for off-flavor;
iv. generating chickpea flour from the deoiled chickpea flakes; and
v. recycling the solvent used for deoiling.

2. The process as claimed in claim 1, wherein the step of preparing chickpeas further includes:
a. cleaning the raw chickpeas in a classifier separator to remove all the foreign and unwanted matter from the raw material;
b. feeding the aforesaid chickpeas into a splitter machine to get the chickpea splits;
c. feeding the splits into a cracker machine to crack them into broken chickpeas; and
d. removing the residual powder generated in the previous step using an aspirator.

3. The process as claimed in claim 1, wherein the step of treating the broken chickpeas further includes:
a. feeding the broken chickpeas into a vessel with stirrer, via a screw conveyor with addition of water to achieve a predefined moisture level;
b. conditioning of the broken chickpeas by resting it for a predefined period of time with intermittent stirring or continuous slow stirring to attain moisture equilibrium;
c. cooking the conditioned broken chickpeas for a predefined period of time with intermittent stirring or continuous slow stirring in a vessel jacketed with water of a predefined temperature; and
d. feeding the cooked broken chickpeas of the previous step into a flaker machine to obtain chickpea flakes of predefined thickness.

4. The process as claimed in claim 1, wherein the step of deoiling the chickpea flakes further includes:
a. deoiling of the chickpea flakes in an extractor vessel using a predefined solvent, wherein the extractor is heated at a predefined temperature using hot water; and
b. draining the remaining solvent with miscella of the previous step and feeding the deoiled chickpea flakes of the previous step into a vacuum evaporator, via a conveyor from extractor to evaporator and keeping the chickpea flakes in intermittent or continuous slow stirring in the extractor.

5. The process as claimed in claim 1, wherein the step of generating chickpea flour from the deoiled chickpea flakes further includes:
a. desolventizing the chickpea flakes by stirring continuously in the vacuum evaporator, where the vacuum is maintained at a predefined pressure and the water jacket is maintained at a predefined temperature, to a point where the solvent content is reduced;
b. transferring the deoiled, desolventized chickpea flakes into a vessel to allow cooling of the chickpea flakes to an ambient temperature; and
c. feeding the chickpea flakes of the previous step to an air classifying mill where the chickpea flakes are ground to give chickpea flour.

6. The process as claimed in claim 1, wherein the step of recycling the predefined solvent further includes:
a. feeding the miscella (oil with solvent) generated in the deoiling step of the process into an evaporator wherein the oil is separated from the miscella by evaporating the solvent; and
b. feeding the diluted solvent to a rectification column wherein the solvent is rectified to a concentration range of 95% to 96% and recycled back to the process again.

7. The process as claimed in claim 1, wherein the size of the broken chickpeas is in the range of 2-4 mm.

8. The process as claimed in claim 3, wherein the predefined moisture level achieved is in the range of 12-15%.

9. The process as claimed in claim 3, wherein the predefined period of time for conditioning the broken chickpeas is in the range of 30-150 minutes.

10. The process as claimed in claim 3, wherein the predefined period of time for cooking the conditioned broken chickpeas is in the range of 100-120 minutes.

11. The process as claimed in claim 3, wherein the predefined temperature of the vessel jacketed with water used for cooking the conditioned broken chickpeas is in the range of 60° C.-70° C.

12. The process as claimed in claim 3, wherein the predefined thickness of the chickpea flakes is in the range of 0.3 mm-0.8 mm.

13. The process as claimed in claim 4, wherein the predefined solvent is selected from one or more of polar solvents such as methanol, ethanol, acetic acid and/or one or more of non-polar solvents such as carbon tetrachloride, benzene, diethyl ether, hexane and methylene chloride.

14. The process as claimed in claim 13, wherein the predefined solvent has a concentration in the range of 95%-96%.

15. The process as claimed in claim 4, wherein the predefined temperature used to heat the extractor vessel is in the range of 45° C.-50° C.

16. The process as claimed in claim 5, wherein the desolventization of chickpea flakes is done in a vacuum evaporator having a predefined pressure in the range of 60-3000 Torr (mmHG).

17. The process as claimed in claim 5, wherein the desolventization of chickpea flakes is done in a vacuum evaporator with a water jacket having a predefined temperature in the range of 50° C.-55° C.

18. A chickpea flour made by the process as claimed in claim 1.

19. A chickpea flour as claimed in claim 13, wherein the flour is flavorless, tasteless and has improved functionality.
